(19) United States
(12) Patent Application Publication
(10) Pub. No.: US 2005/0273472 A1
(43) Pub. Date: Dec. 8, 2005

(54) Verifying incremental updates to hierarchicaly structured information

(76) Inventors: Prakash Reddy, Fremont, CA (US); James A. Rowson, Fremont, CA (US); Eamonn O'Brien-Strain, San Mateo, CA (US); Robert N. Mayo, Mountain View, CA (US); Yuhong Xiong, Fremont, CA (US); Kan Zhang, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/861,292

(22) Filed: Jun. 4, 2004

(51) Int. Cl. G06F 17/30; G06F 12/00; G06F 17/00

(52) U.S. Cl. 707/104.1

(57) ABSTRACT

Techniques for verifying whether an incremental update was correctly applied to a set of hierarchically structured information include determining an overall integrity code for the hierarchically structured information and attaching the overall integrity code to the hierarchically structured information. An incremental update according to the present techniques includes an integrity code that is combined into the overall integrity code attached to the hierarchically structured information when the incremental update is applied to the hierarchically structured information. The integrity code of the incremental update is generated such that when the overall integrity code is recomputed it will match the overall integrity code attached to the hierarchically structured information if the incremental update was correctly applied.

### BACKGROUND

A wide variety of information may be represented in a hierarchical structure. One example format for representing information in a hierarchical structure is the extensible markup language (XML) format. An XML document may include an arrangement of nodes containing information and may specify parent-child relationships among the nodes.

It may be desirable under a variety of circumstances to apply incremental updates to hierarchically structured information. For example, a computing system may include a variety of processing devices that each generate incremental updates to an XML document.

A processing device that generates an incremental update to hierarchically structured information may be viewed as a trusted device in terms of access to the information. On the other hand, a processing device that applies an incremental update to hierarchically structured information may be viewed as an un-trusted device in terms of access to the information. For example, an XML document may be stored on a network-based information storage facility. As a consequence, it may be desirable to verify whether or not an incremental update handled by an un-trusted device was correctly applied to hierarchically structured information.

### SUMMARY OF THE INVENTION

Techniques are disclosed for verifying whether an incremental update was correctly applied to a set of hierarchically structured information. The present techniques include determining an overall integrity code for the hierarchically structured information and attaching the overall integrity code to the hierarchically structured information. An incremental update according to the present techniques includes an integrity code that is combined into the overall integrity code attached to the hierarchically structured information when the incremental update is applied to the hierarchically structured information. The integrity code of the incremental update is generated such that when the overall integrity code is recomputed it will match the overall integrity code attached to the hierarchically structured information if the incremental update was correctly applied.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows a computing system that enables verification of incremental updates to a set of hierarchically structured information according to the present techniques;

FIG. 2 shows an example representation of the unencrypted contents of a set of hierarchically structured information;

FIG. 3 shows a method for encrypting a set of hierarchically structured information according to the present techniques;

FIG. 4 shows a method for generating an overall integrity code (OIC) for a set of hierarchically structured information;

FIG. 5 shows a method for adding a node to a set of hierarchically structured information;

FIG. 6 shows a method for deleting a node from a set of hierarchically structured information;

FIG. 7 shows a method for replacing a node in a set of hierarchically structured information;

FIG. 8 shows a method for verifying whether incremental updates to a set of hierarchically structured information were applied correctly.

### DETAILED DESCRIPTION

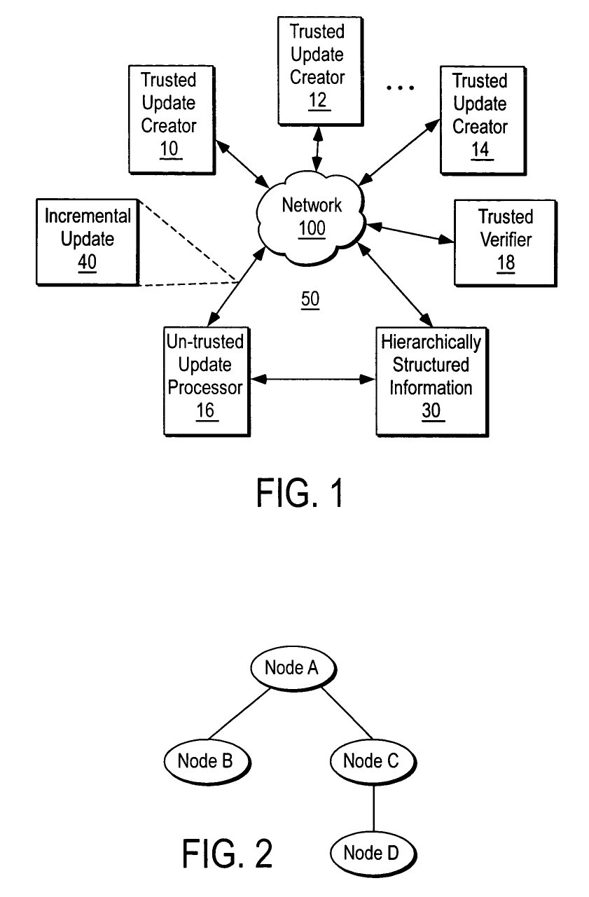

FIG. 1 shows a computing system 50 that enables verification of incremental updates to a set of hierarchically structured information 30 according to the present techniques. The computing system 50 includes a set of trusted update creators 10-14, an un-trusted update processor 16, and a trusted verifier 18. The trusted update creators 10-14, the un-trusted update processor 16, and the trusted verifier 18 communicate via a communication network 100.

The trusted update creators 10-14, the un-trusted update processor 16, and the trusted verifier 18 may be embodied as any combination of computer systems, server systems, storage systems, database systems, mobile computing devices including personal digital assistants (PDAs), cell phones, etc., as well as more specialized processing devices. The communication network 100 may be embodied as any combination of communication links including public communication links, wireless communication links, Internet communication links, etc.

The trusted update creators 10-14 are trusted with respect to the contents of the hierarchically structured information 30 whereas the un-trusted update processor 16 is not trusted with respect to the contents of the hierarchically structured information 30. For example, the trusted update creators 10-14 may be application programs that generate updates to the contents of the hierarchically structured information 30 and the un-trusted update processor 16 may be a document storage service that provides storage and access to the hierarchically structured information 30. The contents of the hierarchically structured information 30 are encrypted to prevent exposure of its contents, for example from exposure to the un-trusted update processor 16.

The trusted update creators 10-14 generate incremental updates, e.g. an incremental update 40, that are to be applied to the hierarchically structured information 30. The un-trusted update processor 16 applies the incremental update 40 to the hierarchically structured information 30 without decrypting the contents of the hierarchically structured information 30.

The unencrypted contents of the hierarchically structured information 30 may be represented as a hierarchical tree structure having an arrangement of nodes and arcs. The hierarchically structured information 30 is encoded and encrypted in such a way as to prevent unauthorized viewing and modification of its content as well as unauthorized viewing of its hierarchical structure. The hierarchical structure of the hierarchically structured information 30 is hidden in order to prevent unauthorized persons from inferring the information contained in the encrypted hierarchically structured information 30 from its hierarchical structure. For example, unauthorized persons are prevented from inferring the information contained in the hierarchically structured information 30 by determining parent-child relationships among its nodes.

FIG. 2 shows an example representation of the unencrypted contents of the hierarchically structured information 30. The unencrypted contents of the hierarchically structured information 30 are arranged in a set of nodes A-D and interconnecting arcs that define parent-child relationships among the nodes A-D. The node A is the parent of the nodes B and C. The node C is the parent of the node D.

Each node A-D may be represented using a data structure that includes a tag, a set of zero or more attributes, and zero or more text strings. The contents of the data structure for each node A-D that is not the root node of the hierarchically structured information 30 refers to its parent node. The contents of the data structure for each node A-D may refer to an ordered list of child nodes.

An example data structure for representing the unencrypted contents of the hierarchically structured information 30 is a data structure in XML format. An example of the unencrypted contents of the hierarchically structured information 30 in XML format is as follows.

<base web=“lime.org”>

Ok rock.
<color>White</color>
<value basic=“cheap”>

<dollars>29.33</dollars>

</value>

</base>

The hierarchically structured information 30 is encrypted in two phases—an encoding phase followed by an encryption phase. In the encoding phase, the hierarchical structure of the unencrypted contents of the hierarchically structured information 30 is flattened into an unordered list of nodes. In the encryption phase, the unordered list of nodes is encrypted.

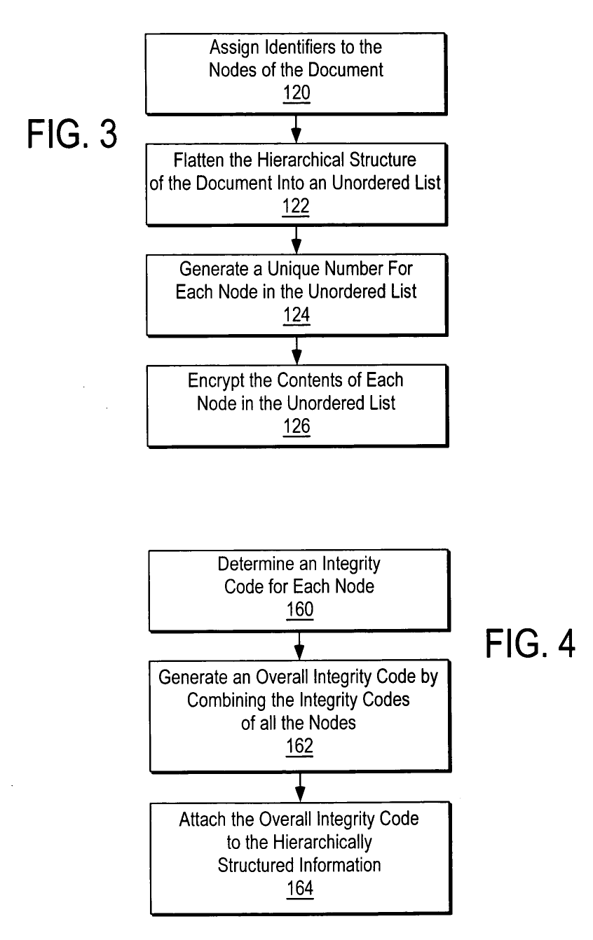

FIG. 3 shows a method for encrypting the hierarchically structured information 30 according to the present techniques. The following description treats the structure of the hierarchically structured information 30 as a set of lines of text, each line of text corresponding to a node and specifies the corresponding parent, if any and corresponding child nodes if any. The structure of the hierarchically structured information 30 may alternatively be represented using other types of data representations, e.g. a set of records in a C programming language data structure.

At step 120, an arbitrary identifier is assigned to each node A-D of the hierarchically structured information 30. The node identifiers remain persistently assigned to the nodes A-D. An example assignment of arbitrary identifiers for the nodes A-D is as follows.

| | |
|---|---|
| Node A | 109 |
| Node B | 558 |
| Node C | 971 |
| Node D | 623 |

The textual representation of the hierarchically structured information 30 after step 120 is as follows wherein the node identifiers 109, 558, 971, and 623 are shown below in square brackets.

<base [109] web=“lime.org>”

Ok rock.
<color [558]>White</color>
<value [971] basic=“cheap”>

<dollars [623] >29.33</dollars>

</value>

</base>

At step 122, the hierarchical structure of the hierarchically structured information 30 is flattened into an unordered list representing the nodes, i.e. the nodes in the list have no particular order in relation to the hierarchical structure of the hierarchically structured information 30.

The following is an unordered list representation for the example hierarchically structured information 30 after step 122.
[971] parent 109, <value basic=“cheap” [623]>
[623] parent 971, <dollars>29.33</dollars>
[109] parent root, <base web=“lime.org”>Ok rock. [558] [971]</base>
[558] parent 109, <color>White</color>

The first entry in the unordered list from step 122 specifies that the node 971 has a parent node 109 and a child node 623. The second entry in the unordered list from step 122 specifies that the node 623 has a parent node 971. The third entry in the unordered list from step 122 specifies that the node 109 is a root node and has child nodes 558 and 971, in that order. The fourth entry in the unordered list from step 122 specifies that the node 558 has a parent node 109.

The ordering of the node identifiers 971, 623, 109, and 558 in the unordered list from step 122 does not reflect the hierarchical structure of the example hierarchically structured information 30. This prevents unauthorized parties from grasping the structure of the hierarchically structured information 30 from the arrangement of the unencrypted node identifiers 971, 623, 109, and 558.

At step 124, a unique number (U) is generated for each node of the unordered list from step 122. For example, the unique number for the node 971 is U₉₇₁ and the unique number for the node 623 is U₆₂₃. The unique number helps ensure the uniqueness in the data of each entry in the unordered list. The unique number may be obtained from a random number generator or another function generator.

At step 126, the contents of each entry in the unordered list is encrypted. The node identifier for each entry in the unordered list is not encrypted. The unordered list representing the hierarchically structured information 30 after step 104 is as follows where the encryption function is E( ).
[971] E(U₉₇₁, parent 109, <value basic=“cheap” [623]>)
[623] E(U₆₂₃, parent 971, <dollars>29.33</dollars>)
[109] E(U₁₀₉, parent root, <base web=“lime.org>Ok rock. [558] [971]</base>)
[558] E(U₅₅₈, parent 109, <color>White</color>)

The choice of encryption algorithm, encryption key and the choice of symmetric or asymmetric key may be adapted to particular embodiments. The appropriate decryption key is used to decrypt the hierarchically structured information 30.

FIG. 4 shows a method for generating an overall integrity code (OIC) for the hierarchically structured information 30. The method steps shown may be performed by a trusted device, e.g. the trusted update creators 10-14, having access to the unencrypted contents of the hierarchically structured information 30. At step 160, an integrity code (IC) is determined for each node in the unordered list representing the hierarchically structured information 30. In one embodiment, the IC for a node is determined by computing a one way hash of the unique number and the node data including child pointers. For example, the IC₉₇₁ for the node 971 is as follows.
IC₉₇₁=H(U₉₇₁+Data₉₇₁+Refs₉₇₁)

The Data₉₇₁ is the actual data associated with the node 971 and the Refs₉₇₁ are the ordered list of the child references for the node 971. If the data in a node is replaced then the unique number will also be changed ensuring the integrity code is also different.

The one way hash function H generates a fixed width bit stream in response to a text x. The one way hash function H has the property such that there is no computationally feasible method of discovering x given H(x). One example of a suitable hash function is the MD5 function.

At step 162, the integrity codes for all of the nodes in the unordered list representing the hierarchically structured information 30 are combined together to yield the OIC for the hierarchically structured information 30. The integrity codes are combined using a function that is selected such that two integrity codes having the same value will cancel each other out in the combination. One example of a suitable combining function is the exclusive-OR (XOR) function which is used hereinafter to represent the combining function. The order in which the integrity codes of the nodes are combined at step 162 can be any order.

At step 164, the overall integrity code OIC is attached to the hierarchically structured information 30. For example, the overall integrity code OIC may be stored in the entry of the unordered list that corresponds to the root node.

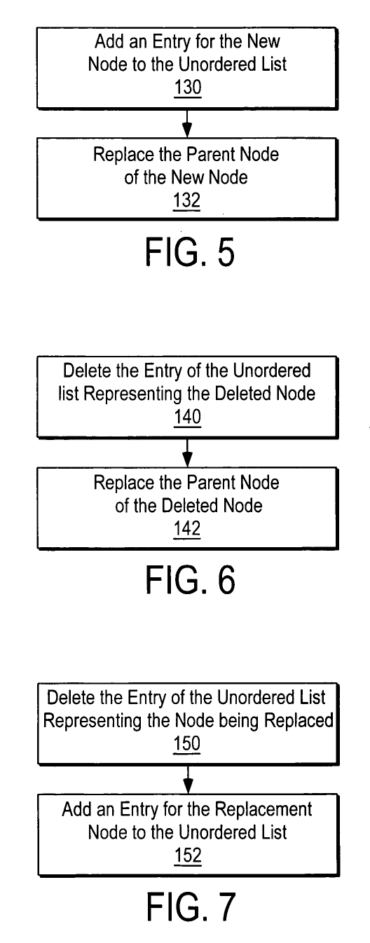

FIG. 5 shows a method for adding a node to the hierarchically structured information 30. For example, a node E may be added as a child node to the node C. At step 130, a new entry representing the node E is added to the unordered list representing hierarchically structured information 30. The new entry includes a node identifier for the node E. At step 132, the entry of the unordered list representing the parent node of the node E, i.e. the node C, is replaced with a new entry that specifies the new child relationship to the new node E. An entry may be added in an arbitrary place in the unordered list.

FIG. 6 shows a method for deleting a node from the hierarchically structured information 30. For example, the node B may be deleted from the hierarchically structured information 30. At step 140, the entry representing the node B is deleted from the unordered list representing the hierarchically structured information 30. At step 142, the entry in the unordered list representing the parent node of the node B, i.e. the node A, is replaced with a new entry that removes the child relationship with the deleted node.

FIG. 7 shows a method for replacing a node in the hierarchically structured information 30. For example, the node D may be replaced in the hierarchically structured information 30 because the attributes of the node D may have changed. At step 150, the entry representing the old node D is deleted from the unordered list representing the hierarchically structured information 30. At step 152, a new entry representing the new node D, the replacement node, is added to the unordered list representing the hierarchically structured information 30. The new entry representing the new node D includes the same identifier for as the old node D.

The incremental update 40 specifies nodes to be added to the hierarchically structured information 30 and/or nodes to be deleted and/or nodes to be replaced from the hierarchically structured information 30. The un-trusted update processor 16 adds nodes to and deletes nodes from the hierarchically structured information 30 in response to the incremental update 40 by identifying entries in the unordered list for the nodes to be added or deleted using the node identifiers. This avoids decrypting the portions of the entries containing node data and parent-child pointers, thereby preventing exposure of the contents and hierarchical structure of the hierarchically structured information 30 to the un-trusted update processor 16 as it applies the incremental update 40 to the hierarchically structured information 30.

The incremental update 40 may specify one or more ADD commands and/or one or more DELETE commands and/or one or more REPLACE commands. An ADD command is used to add a node to the hierarchically structured information 30 and a DELETE command is used to delete a node from the hierarchically structured information 30. A REPLACE command is used to replace a node in the hierarchically structured information 30.

An ADD command in one embodiment is as follows.
ADD id, E(txt)

The “id” parameter of the ADD command is a node identifier for a new, node to be added. The “E(txt)” parameter of the ADD command is the encrypted node data for a new entry in the unordered list representing the hierarchically structured information 30 for the new node. The “E(txt)” parameter includes a unique number for the new entry. The un-trusted update processor 16 performs an ADD id, E(txt) command by adding a new entry to the unordered list representing the hierarchically structured information 30 including the node identifier id and E(txt).

A DELETE command in one embodiment is as follows.
DELETE id

The “id” parameter of the DELETE command is a node identifier for a node to be deleted from the hierarchically structured information 30. The un-trusted update processor 16 performs a DELETE id command by deleting the entry from the unordered list representing the hierarchically structured information 30 that is specified by id parameter in the DELETE command.

A REPLACE command in one embodiment is as follows.
REPLACE id, H(E(txt_old)), E(txt)

The “id” parameter of the REPLACE command is a node identifier for a node to be replaced. The “E(txt)” parameter of the REPLACE command is the new encrypted node data. The “H(E(txt_old))” parameter of the REPLACE command is a hash of the old encrypted node data.

The un-trusted update processor 16 performs a REPLACE id, H(E(txt_old)), E(txt) command by computing a hash of the encrypted node data in the entry in the hierarchically structured information 30 identified by the “id” parameter and comparing that hash with H(E(txt_old)) and then replacing the entry in the hierarchically structured information 30 that is identified by the node identifier id with E(txt) if they match. If H(E(txt_old)) does not match the hash of the encrypted node data for the entry in the hierarchically structured information 30 identified by the “id” parameter then the REPLACE id, H(E(txt_old)), E(txt) command is a conflicting attempt to modify a previously modified node which is not allowed. In the case of a conflict of incremental update, the commands are appended to the hierarchically structured information 30 and may later be merged by a trusted node.

The un-trusted update processor 16 applies the incremental update 40 to the hierarchically structured information 30 by performing the specified ADD and DELETE and REPLACE commands without decrypting the individual entries of the hierarchically structured information 30. The un-trusted update processor 16 recognizes the unencrypted node identifiers in the entries of the unordered list and then deletes and adds the specified lines.

The following is a first example of the incremental update 40 for the example hierarchically structured information 30.

ADD 421, E(U₄₂₁, parent 971, <dollars>31.27</dollars>)
REPLACE 971, E(U′₉₇₁, parent 109, <value basic=“cheap” [623] [421]>)

The ADD command adds a child node to node 971, and the REPLACE command provides an updated parent node 971 including a new unique number U′₉₇₁ and child pointers for the update parent node 971. Alternatively, the same unique number U₉₇₁ may be used.

Before the first example incremental update 40 is applied, the example hierarchically structured information 30 is as follows.
[971] E(U₉₇₁, parent 109, <value basic=“cheap” [623]>)
[623] E(U₆₂₃, parent 971, <dollars>29.33</dollars>)
[109] E(U₁₀₉, parent root, <base web=“lime.org>Ok rock. [558] [971]</base>)
[558] E(U₅₅₈, parent 109, <color[558]>White</color>)

After the first example incremental update 40 is applied the example hierarchically structured information 30 is as follows.
[623] E(U₆₂₃, parent 971, <dollars>29.33</dollars>)
[109] E(U₁₀₉, parent root, <base web=“lime.org>Ok rock. [558] [971]</base>)
[558] E(U₅₅₈, parent 109, <color[558]>White</color>)
[421] E(U₄₂₁, parent 971, <dollars>31.27</dollars>)
[971] E(U′₉₇₁, parent 109, <value basic=“cheap” [623] [421]>)

The following is a second example of the incremental update 40 for the example hierarchically structured information 30.
DELETE 558
REPLACE 109, E(U′₁₀₉, parent root, <base web=“lime.org>Ok rock. [971]</base>)

The DELETE command deletes the node 558, a child node to the root node 109, and the REPLACE command provides an updated root node 109 including a new unique number U′₁₀₉ and updated child pointers.

Before the second example incremental update 40 is applied the example hierarchically structured information 30 is as follows.
[971] E(U₉₇₁, parent 109, <value basic=“cheap” [623]>)
[623] E(U₆₂₃, parent 971, <dollars>29.33</dollars>)
[109] E(U₁₀₉, parent root, <base web=“lime.org>Ok rock. [558] [971]</base>)
[558] E(U₅₅₈, parent 109, <color[558]>White</color>)

After the second example incremental update 40 is applied the example hierarchically structured information 30 is as follows.
[971] E(U₉₇₁, parent 109, <value basic=“cheap” [623]>)
[623] E(U₆₂₃, parent 971, <dollars>29.33</dollars>)
[109] E(U′₁₀₉, parent root, <base web=“lime.org>Ok rock. [971]</base>)

The incremental update 40 includes an incremental integrity code (IIC) to be applied to the overall integrity code OIC attached to the hierarchically structured information 30. The IIC for the incremental update 40 is determined by determining an integrity code update ICU for each command specified in the incremental update 40 and then combining together the ICUs. For example, if the incremental update 40 includes an ADD command followed by a REPLACE command then the IIC for the incremental update 40 is as follows.
IIC=ICU_{A} XOR ICU_{R}

The ICU_{A} is the ICU for the ADD command and the ICU_{R} is the ICU for the REPLACE command in the incremental update 40.

The ICU_{A} is determined as follows.

ICU_{A}=IC_{A}

The IC_{A} is the integrity code for the node to be added with the ADD command. The integrity code IC_{A} is computed using a one way hash of the corresponding unique number and the corresponding node data including child pointers.

The ICU_{R} is determined as follows.
ICU_{R}=IC_{R} XOR IC_{R}′

The IC_{R}′ is the integrity code for the node to be replaced by the REPLACE command the IC_{R} is the integrity code for the replacement node in the REPLACE command. The integrity codes IC_{R} and IC_{R}′ are each determined by computing a one way hash of the corresponding unique number and the corresponding node data including child pointers.

In another example, if the incremental update 40 includes an DELETE command followed by a REPLACE command then the IIC for the incremental update 40 is as follows.
IIC=ICU_{D} XOR ICU_{R}

The ICU_{D} is the ICU for the DELETE command and the ICU_{R} is the ICU for the REPLACE command in the incremental update 40.

The ICU_{D} is determined as follows.
ICU_{D}=IC_{D}

The IC_{D} is the integrity code for the node to be deleted by the DELETE command. The integrity codes IC_{D} is determined by computing a one way hash of the corresponding unique number and the corresponding node data including child pointers.

The un-trusted update processor 16 applies the IIC to the hierarchically structured information 30 when it applies the incremental update 40 to the hierarchically structured information 30. The un-trusted update processor 16 applies the IIC to the hierarchically structured information 30 by obtaining the OIC attached to the hierarchically structured information 30 and obtaining the IIC from the incremental update 40 and computing OIC XOR IIC and then attaching the result back into the hierarchically structured information 30 as the updated OIC for the hierarchically structured information 30.

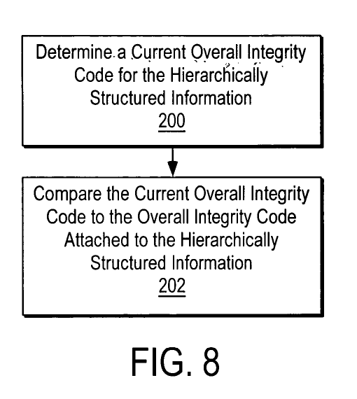

FIG. 8 shows a method for verifying whether incremental updates to the hierarchically structured information 30 were applied correctly. The method steps shown may be performed by a trusted device, e.g. the trusted verifier 18, having access to the unencrypted contents of the hierarchically structured information 30.

At step 200, a current overall integrity code OIC′ for the hierarchically structured information 30 is determined. The OIC′ may determined using method steps analogous to the method steps 160-162 above but with the current contents of the hierarchically structured information 30.

At step 202, the OIC′ is compared to the OIC attached to the hierarchically structured information 30. If OIC′ equals OIC then incremental updates, e.g. the incremental update 40, were applied correctly to the hierarchically structured information 30. If OIC′ does not equal OIC then incremental updates, e.g. the incremental update 40, were not applied correctly to the hierarchically structured information 30.

Add and subtract operations may used to combine integrity codes rather than an XOR function as described above. An add operation may be performed in place of the XOR operation described above, except when removing the old value of a node. Removing an old value of a node occurs when computing the ICUs for the DELETE and REPLACE commands. A set of formulas for computing an integrity code update for the DELETE and REPLACE commands are as follows.
ICU_{D}=0−IC_{D}
ICU_{R}=IC_{R}−IC_{R}′

Other suitable functions for combining integrity code updates may be employed in other embodiments.

The foregoing detailed description of the present invention is provided for the purposes of illustration and is not intended to be exhaustive or to limit the invention to the precise embodiment disclosed. Accordingly, the scope of the present invention is defined by the appended claims.

1. A method for verifying an incremental update to a set of hierarchically structured information, comprising:
associating an overall integrity code to the hierarchically structured information;
determining an integrity code for the incremental update;
combining the integrity code for the incremental update into the overall integrity code associated to the hierarchically structured information when the incremental update is applied to the hierarchically structured information.

2. The method of claim 1, further comprising determining the overall integrity code by:
determining an integrity code for each of a set of nodes represented in the hierarchically structured information;
combining the integrity codes.

3. The method of claim 1, further comprising determining a current overall integrity code for the hierarchically structured information and comparing the current overall integrity code to the overall integrity code associated to the hierarchically structured information.

4. The method of claim 1, wherein determining an integrity code for the incremental update includes:
determining an integrity code for an add command in the incremental update;
determining an integrity code for a replace command in the incremental update;
combining the integrity code for the add command with the integrity code for the replace command.

5. The method of claim 4, wherein determining an integrity code for an add command includes determining a one way hash of a unique number and a set of node data for the add command.

6. The method of claim 4, wherein determining an integrity code for a replace command includes:
determining a one way hash of a unique number and a set of node data for a node in the hierarchically structured information replaced with the replace command;
determining a one way hash of a unique number and a set of node data for a replacement node of the replace command;
combining the one way hashes.

7. The method of claim 1, wherein determining an integrity code for the incremental update includes:
determining an integrity code for a delete command in the incremental update;
determining an integrity code for a replace command in the incremental update;
combining the integrity code for the delete command with the integrity code for the replace command.

8. The method of claim 7, wherein determining an integrity code for a delete command includes determining a one way hash of a unique number and a set of node data for the delete command.

9. The method of claim 7, wherein determining an integrity code for a replace command includes:
determining a one way hash of a unique number and a set of node data for a node in the hierarchically structured information replaced with the replace command;
determining a one way hash of a unique number and a set of node data for a replacement node of the replace command;
combining the one way hashes.

10. A method for verifying an incremental update to a set of hierarchically structured information, comprising:
obtaining an overall integrity code associated to the hierarchically structured information;
obtaining an integrity code for the incremental update;
combining the integrity code for the incremental update into the overall integrity code associated to the hierarchically structured information when the incremental update is applied to the hierarchically structured information.

11. A method for verifying an incremental update to a set of hierarchically structured information, comprising:
determining an overall integrity code for the hierarchically structured information;
associating the overall integrity code to the hierarchically structured information;
determining an integrity code for the incremental update such that the integrity code for the incremental update when combined into the overall integrity code associated to the hierarchically structured information enables verification of the incremental update.

12. The method of claim 11, wherein determining an overall integrity code includes:
determining an integrity code for each of a set of nodes represented in the hierarchically structured information;
combining the integrity codes.

13. The method of claim 11, further comprising determining a current overall integrity code for the hierarchically structured information and comparing the current overall integrity code to the overall integrity code associated to the hierarchically structured information.

14. The method of claim 11, wherein determining an integrity code for the incremental update includes:
determining an integrity code for an add command in the incremental update;
determining an integrity code for a replace command in the incremental update;
combining the integrity code for the add command with the integrity code for the replace command.

15. The method of claim 14, wherein determining an integrity code for an add command includes determining a one way hash of a unique number and a set of node data for the add command.

16. The method of claim 14, wherein determining an integrity code for a replace command includes:
determining a one way hash of a unique number and a set of node data for a node in the hierarchically structured information replaced with the replace command;
determining a one way hash of a unique number and a set of node data for a replacement node of the replace command;
combining the one way hashes.

17. The method of claim 11, wherein determining an integrity code for the incremental update includes:
determining an integrity code for a delete command in the incremental update;
determining an integrity code for a replace command in the incremental update;
combining the integrity code for the delete command with the integrity code for the replace command.

18. The method of claim 17, wherein determining an integrity code for a delete command includes determining a one way hash of a unique number and a set of node data for the delete command.

19. The method of claim 17, wherein determining an integrity code for a replace command includes:
determining a one way hash of a unique number and a set of node data for a node in the hierarchically structured information replaced with the replace command;
determining a one way hash of a unique number and a set of node data for a replacement node of the replace command;
combining the one way hashes.

20. A computing system, comprising:
update creator that generates an incremental update to a set of hierarchically structured information and that determines an integrity code for the incremental update;
update processor that combines the integrity code for the incremental update into an overall integrity code associated to the hierarchically structured information when the incremental update is applied to the hierarchically structured information.

21. The computing system of claim 20, further comprising a verifier that determines a current overall integrity code for the hierarchically structured information and compares the current overall integrity code to the overall integrity code associated to the hierarchically structured information.

22. The computing system of claim 20, wherein the update creator determines the integrity code for the incremental update by determining an integrity code for an add command in the incremental update and determining an integrity code for a replace command in the incremental update and combining the integrity code for the add command with the integrity code for the replace command.

23. The computing system of claim 20, wherein the update creator determines the integrity code for the incremental update by determining an integrity code for a delete command in the incremental update and determining an integrity code for a replace command in the incremental update and combining the integrity code for the delete command with the integrity code for the replace command.

24. A computing system having an update creator that generates an incremental update to a set of hierarchically structured information and that determines an integrity code for the incremental update such that the integrity code for the incremental update is combined into an overall integrity code associated to the hierarchically structured information when the incremental update is applied to the hierarchically structured information.

25. The computing system of claim 24, further comprising a verifier that determines a current overall integrity code for the hierarchically structured information and compares the current overall integrity code to the overall integrity code associated to the hierarchically structured information.

26. The computing system of claim 24, wherein the update creator determines the integrity code for the incremental update by determining an integrity code for an add command in the incremental update and determining an integrity code for a replace command in the incremental update and combining the integrity code for the add command with the integrity code for the replace command.

27. The computing system of claim 24, wherein the update creator determines the integrity code for the incremental update by determining an integrity code for a delete command in the incremental update and determining an integrity code for a replace command in the incremental update and combining the integrity code for the delete command with the integrity code for the replace command.

28. A computing system having an update processor that obtains an incremental update to a set of hierarchically structured information including an integrity code for the incremental update and that combines the integrity code for the incremental update into an overall integrity code associated to the hierarchically structured information when the incremental update is applied to the hierarchically structured information.
